(19) United States
(12) Patent Application Publication
(10) Pub. No.: US 2025/0209457 A1
(43) Pub. Date: Jun. 26, 2025

(54) Apparatus, System, and Method for Enabling Secure Transactions with Haptic Authorization

(71) Applicant: Visa International Service Association, San Francisco, CA (US)

(72) Inventors: Anika Tibrewala, Boisar (IN); . Jody, Singapore (SG); Chinmay Hebbar, Pune (IN)

(21) Appl. No.: 18/396,099

(22) Filed: Dec. 26, 2023

(51) Int. Cl. G06Q 20/40; G06F 3/01; G06Q 20/38

(52) U.S. Cl. CPC G06Q 20/4012; G06F 3/016; G06Q 20/3825

(57) ABSTRACT

Provided herein is a system for authorizing a transaction, including at least one processor programmed or configured to receive, from a merchant system, a request to authorize a transaction, the request comprising at least one token associated with a user, determine, based at least on the at least one token, that the user requested a haptic personal identification number (PIN), transmit, to a payment device associated with the user, a haptic PIN, receive, from the payment device, a responsive PIN, determine that the responsive PIN matches the haptic PIN, and in response to determining that the responsive PIN matches the haptic PIN, automatically authorize the transaction. Systems and computer program products are also provided.

### BACKGROUND

### Field

This disclosure relates generally to payment devices and methods of using the same, and particularly, an apparatus, system, and method for enabling secure transactions with haptic authentication.

### Technical Considerations

In some scenarios, transactions may benefit from haptic authentication. For example, with individuals who may be visually impaired and who make use of multi-factor authentication, use of a haptic code, rather than a code that is received by email or text, may be preferable in terms of increased security. Accordingly, there is a need in the art for apparatuses, systems, and methods that can allow for increased security during transactions.

### SUMMARY

Provided herein is a system for authorizing a transaction, including at least one processor programmed or configured to receive, from a merchant system, a request to authorize a transaction, the request including at least one token associated with a user, determine, based at least on the at least one token, that the user requested a haptic personal identification number (PIN), transmit, to a payment device associated with the user, a haptic PIN, receive, from the payment device, a responsive PIN, determine that the responsive PIN matches the haptic PIN, and in response to determining that the responsive PIN matches the haptic PIN, automatically authorize the transaction.

Also provided herein is a computer-implemented method including steps of receiving, with at least one processor, a request to authorize a transaction, the request including at least one token associated with a user, querying, with at least one processor, a database to determine that the user is registered for a haptic PIN based at least on the at least one token, in response to determining that the user is registered for a haptic PIN, transmitting, with at least one processor, a haptic PIN to a payment device associated with the user, receiving, with at least one processor, a user input comprising a pattern, determining that the pattern matches the haptic PIN by comparing, with at least one processor, the pattern to the haptic PIN, and in response to determining that the pattern matches the haptic PIN, authorizing, with at least one processor, the transaction.

Also provided herein is a non-transitory, computer-readable medium, having stored thereon programming instructions that, when executed by at least one processor, cause the at least one processor to receive, from a merchant system, a request to authorize a transaction, the request including at least one token associated with a user, determine, based at least on the at least one token, that the user requested a haptic personal identification number (PIN), transmit, to a payment device associated with the user, a haptic PIN, receive, from the payment device, a responsive PIN, determine that the responsive PIN matches the haptic PIN, and in response to determining that the responsive PIN matches the haptic PIN, automatically authorize the transaction.

Also provided herein is a system for authorizing an action, including at least one processor programmed or configured to receive, from a system, a request to authorize an action, the request including at least one identifier associated with a user, determine, based at least on the at least one identifier, that the user requested a haptic personal identification number (PIN), transmit, to a device associated with the user, a haptic PIN, receive, from the device associated with the user, a responsive PIN, determine that the responsive PIN matches the haptic PIN, and in response to determining that the responsive PIN matches the haptic PIN, automatically authorize the action.

Further non-limiting embodiments are set forth in the following numbered clauses:
Clause 1: A system for authorizing a transaction, comprising: at least one processor programmed or configured to: receive, from a merchant system, a request to authorize a transaction, the request comprising at least one token associated with a user; determine, based at least on the at least one token, that the user requested a haptic personal identification number (PIN); transmit, to a payment device associated with the user, a haptic PIN; receive, from the payment device, a responsive PIN; determine that the responsive PIN matches the haptic PIN; and in response to determining that the responsive PIN matches the haptic PIN, automatically authorize the transaction.
Clause 2: The system of clause 1, wherein the responsive PIN is transmitted from the payment device to the merchant system and received by the at least one processor from the merchant system.
Clause 3: The system of clause 1 or clause 2, wherein the at least one token comprises at least two tokens.
Clause 4: The system of any of clauses 1-3, wherein at least one first token of the at least two tokens comprises data relating to the haptic PIN, and wherein at least one second token of the at least two tokens comprises data relating to account information associated with the user.
Clause 5: The system of any of clauses 1-4, wherein the at least one processor is further programmed or configured to transmit the haptic PIN via an application stored on the payment device.
Clause 6: The system of any of clauses 1-5, wherein the at least one processor is further programmed or configured to generate a notification that the haptic PIN has been received in response to receiving the haptic PIN.
Clause 7: The system any of clauses 1-6, wherein the at least one processor is further programmed or configured to: prior to receipt of the request to authorize the transaction, receive a request to generate a haptic PIN; and generate the at least one token.
Clause 8: The system of any of clauses 1-7, wherein the at least one processor is further programmed or configured to store, in a database, an association between the request to generate the haptic PIN and the at least one token.
Clause 9: The system of any of clauses 1-8, wherein the at least one processor is further programmed or configured to transmit a notification to the merchant system and/or the payment device based on authorizing the transaction.
Clause 10: A computer-implemented method for authorizing a transaction, comprising: receiving, with at least one processor, a request to authorize a transaction, the request comprising at least one token associated with a user; querying, with at least one processor, a database to determine that the user is registered for a haptic PIN based at least on the at least one token; in response to determining that the user is registered for a haptic PIN, transmitting, with at least one processor, a haptic PIN to a payment device associated with the user; receiving, with at least one processor, a user input comprising a pattern; determining that the pattern matches the haptic PIN by comparing, with at least one processor, the pattern to the haptic PIN; and in response to determining that the pattern matches the haptic PIN, authorizing, with at least one processor, the transaction.
Clause 11: The computer-implemented method of clause 10, wherein the at least one token comprises at least two tokens.
Clause 12: The computer-implemented method of clause 10 or clause 11, wherein at least one first token of the at least two tokens comprises data relating to the haptic PIN, and wherein at least one second token of the at least two tokens comprises data relating to account information associated with the user.
Clause 13: The computer-implemented method of any of clauses 10-12, wherein the haptic PIN is transmitted to the payment device via an application stored on the payment device.
Clause 14: The computer-implemented method of any of clauses 10-13, further comprising generating, with at least one processor and in response to receiving the haptic PIN, a notification that the haptic PIN has been received.
Clause 15: The computer-implemented method of any of clauses 10-14, further comprising: receiving, with at least one processor and prior to receiving the request to authorize the transaction, a request that a haptic PIN be generated; and generating, with at least one processor, the at least one token.
Clause 16: The computer-implemented method of any of clauses 10-15, further comprising storing, in a database and with at least one processor, an association of the request that a haptic PIN be generated and the at least one token.
Clause 17: The computer-implemented method of any of clauses 10-16, further comprising transmitting, with at least one process and in response to authorizing the transaction, a notification to the payment device that the transaction is authorized.
Clause 18: A non-transitory, computer-readable medium, comprising programming instructions that, when executed by at least one processor, cause the at least one processor to: receive, from a merchant system, a request to authorize a transaction, the request comprising at least one token associated with a user; determine, based at least on the at least one token, that the user requested a haptic personal identification number (PIN); transmit, to a payment device associated with the user, a haptic PIN; receive, from the payment device, a responsive PIN; determine that the responsive PIN matches the haptic PIN; and in response to determining that the responsive PIN matches the haptic PIN, automatically authorize the transaction.
Clause 19: The non-transitory, computer-readable medium of clause 18, further comprising programming instructions that cause the at least one processor to generate a notification that the haptic PIN has been received.
Clause 20: The non-transitory, computer-readable medium of clause 18 or clause 19, further comprising programming instructions that cause the at least one processor to store, in a database, an association of a request that the haptic PIN be generated and the at least one token.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of an exemplary environment in which methods, according to non-limiting embodiments or aspects described herein, may be implemented;

FIG. 2 is a schematic diagram of example components of one or more devices of FIG. 1, according to non-limiting embodiments or aspects as described herein;

FIG. 3 is a process diagram of one embodiment or aspect of a method for authorizing a haptic personal identification number (PIN) as described herein;

FIG. 4 is a process diagram of one embodiment or aspect of a method for authorizing an action with a haptic PIN as described herein; and

FIG. 5 is a process diagram of one embodiment or aspect of a method for authorizing an action with a haptic PIN as described herein.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” and be indicative of a condition for automatically triggering a specified operation of an electronic device (e.g., a processor, a computing device, etc.) as appropriately referred to herein.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction service provider” includes “transaction processing system,” which may refer to one or more computer systems operated by or on behalf of a transaction service provider, such as a transaction processing server executing one or more software applications. A transaction processing server may include at least one processor and, in non-limiting embodiments or aspects, may be operated by or on behalf of a transaction service provider.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In non-limiting embodiments or aspects, an acquirer institution may be a financial institution, such as a bank. As used herein, the term “acquirer institution” includes “acquirer institution system,” which may refer to one or more computing devices operated by or on behalf of an acquirer institution, such as a server computer executing one or more software applications.

As used herein, the term “issuer institution” may refer to one or more entities, such as a bank, that provides accounts to customers for conducting payment transactions, such as initiating credit and/or debit payments. For example, an issuer institution may provide an account identifier, such as a PAN, to a customer that uniquely identifies one or more accounts associated with that customer. The account identifier may be embodied on a physical financial instrument, such as a payment card, and/or may be electronic and used for electronic payments. As used herein, the term “account identifier” may include one or more PANs, tokens, or other identifiers associated with a customer account. An account identifier may be directly or indirectly associated with an issuer institution, such that an account identifier may be a token that maps to a PAN or other type of account identifier. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifiers in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. Such computers may also include point-of-sale devices.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In non-limiting embodiments or aspects, a POS system (e.g., a merchant POS system) may include one or more server computers programmed or configured to process online payment transactions through webpages, mobile applications, and/or the like.

As used herein, the term “payment device” may refer to a portable financial device, an electronic payment device, a computing device as described herein, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In non-limiting embodiments, the payment device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Reference to any component using the indefinite article “a” or the phrase “at least one” may refer to a previously-recited component recited as performing or being involved in a previous step or function, a different component, and/or a combination of components. For example, as used in the specification and the claims, a first processor or at least one processor that is recited as performing a first step or function may refer to the same or different processor recited as performing a second step or function.

Provided herein are devices, systems, and methods for providing increased security during transaction processing, particularly through the use of varied forms of multi-factor authentication (MFA). Such increased security may be provided through use of a haptic personal identification number (PIN) during an MFA process. Use of a haptic PIN may be of particular use by individuals with visual impairments and may also provide increased security from fraudsters. Non-limiting embodiments leverage components of payment devices that are not used in existing authentication processes, such as haptic drivers, to increase security and provide accessibility to users without requiring modified hardware components.

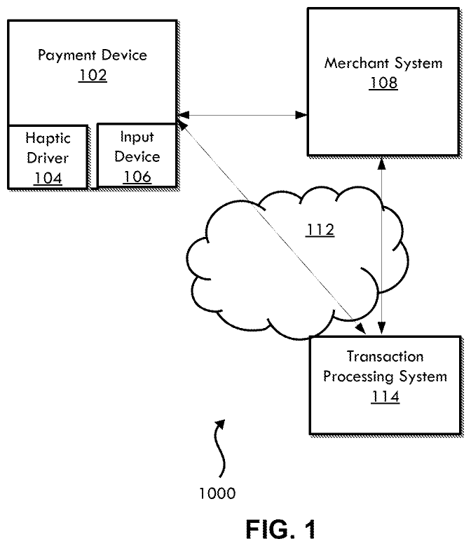

Turning to FIG. 1, shown is a system 1000 including payment device 102 as described herein, merchant system 108 as described herein, transaction processing system 114 as described herein, and network 112. While transaction processing system 114 is exemplified in FIG. 1, those of skill will appreciate that merchant system 108 and/or payment device 102 may communicate with an acquirer institution, issuer institution, and/or a transaction service provider. Components of system 1000 may communicate through network 112, though in non-limiting embodiments or aspects, payment device 102 may communicate with merchant system 108 (for example, when merchant system 108 is a POS device) through NFC or another wireless communication protocol, and with transaction processing system 114 through network 112 (e.g., a public or private network). It will be appreciated that other communicative arrangements as possible.

In non-limiting embodiments or aspects, payment device 102 is a computing device, such as a mobile device personal computer, laptop computer, or the like. In non-limiting embodiments or aspects, payment device 102 may include haptic driver 104. Suitable haptic drivers for use in the systems and methods, described herein, may transform electrical energy to mechanical energy. For example, a haptic driver may include one or more actuators, such as a linear resonant actuator, motors, such as a vibration motor, piezoelectric transducers, and/or the like. In non-limiting embodiments or aspects, a haptic PIN, as described herein, is not transformed to an alphanumeric PIN by any component of system 1000 or any other system or device. In non-limiting embodiments or aspects, payment device 102 may include input device 106. In non-limiting embodiments or aspects, input device 106 may include a touch-screen interface, a keyboard, a mouse, or like input. In some examples, however, input device 106 may be separate from the payment device 102.

In non-limiting embodiments or aspects, payment device 102 may have stored thereon account data, such as a PAN (e.g., a PAN associated with payment device 102) and/or a token associated with such a PAN. In non-limiting embodiments or aspects, payment device 102 may have a plurality of tokens stored thereon. In non-limiting embodiments or aspects, payment device 102 may include an electronic wallet application that includes one or more tokens. In non-limiting embodiments or aspects, one or more of the plurality of tokens may include data relating to MFA, such as information relating to use of a haptic PIN, and one or more of the plurality of tokens may include data relating to the PAN and/or other account data.

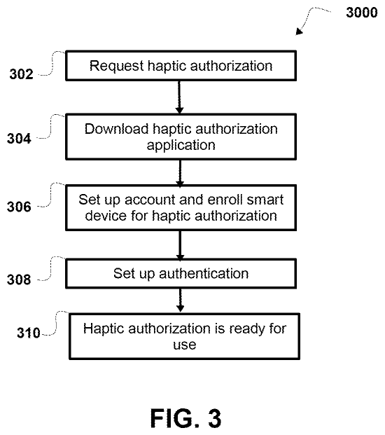

Turning to FIG. 3, shown is a flow diagram of a non-limiting embodiment of a method 3000 for authorizing use of a haptic PIN, as described herein. It will be appreciated that additional, fewer, and/or a different order of steps may be performed in non-limiting embodiments. In some non-limiting embodiments, a step may be automatically performed in response to performance and/or completion of a prior step.

One or more steps of method 3000 may be performed by a payment device and/or computing device, for example, a device associated with a particular user who desires to make use of a haptic PIN in MFA.

As shown in FIG. 3, at step 302, a user submits a request for haptic authorization in MFA. Such a request may, for example, be submitted to an issuer institution and/or a transaction service provider. Step 302 may be performed as part of a registration process when applying for a payment instrument, at a later time, prior to a transaction, and/or the like. At step 304, a user downloads a haptic authorization application, for example, onto a mobile device, personal computer, and/or laptop computer. In some non-limiting embodiments, the haptic authorization application may include or be part of an electronic wallet application. The haptic authorization application may also be a separate application. At step 306, a user may set up and/or identify a payment account to enroll one or more of the user's payment devices for haptic authorization. At step 308, use of a haptic PIN is established. As part of step 308, a user may set up a password and/or other credentials for access to haptic authorization application. Such credentials may be alphanumeric, biometric, and/or may make use of MFA. A secure database may store an association between a payment device and/or account identifier and a flag or other data element to indicate enrollment in haptic authentication. Based on one or more of the prior steps, at step 310, haptic authentication is ready for use in MFA. As part of establishing use of a haptic PIN, issuer institution and/or transaction service provider may generate a token, for example, a token to be stored by one or more of user's enrolled payment devices, such that the token is associated with the request for use of haptic authorization. In non-limiting embodiments or aspects, issuer institution and/or transaction service provider may store an association of the token with the request for use of a haptic PIN. In non-limiting embodiments or aspects, a token associated with the request for use of a haptic PIN (e.g., such as a payment token specifically used for haptic-based payments) is also associated with a user's PAN. In non-limiting embodiments or aspects, a token associated with the request for use of a haptic PIN may be distinct from a token associated with a user's PAN. In non-limiting embodiments or aspects, issuer institution and/or transaction service provider may store an association of user's account data, such as a PAN and/or a token associated with a PAN, with the token relating to use of a haptic PIN and/or the request for use of a haptic PIN.

While the present disclosure exemplifies a haptic PIN for MFA in payment transactions involving merchants, those of skill in the art will appreciate that any action (e.g., transaction, request for access to an account, website, application, and/or device, and/or the like) may include the haptic and responsive PINs as described herein. In non-limiting embodiments, rather than being based on receipt of a request that includes a token, generation and transmission of a haptic PIN may be based on receipt of an account number, username, email address, telephone number, and/or like identifier.

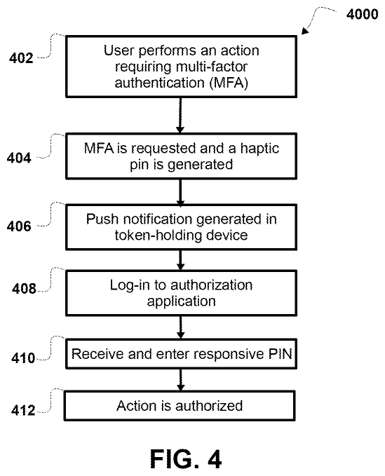

Turning to FIG. 4, shown is a flow diagram of a non-limiting embodiment or aspect of a method 4000 for authorizing an original action including use of a haptic PIN, as described herein. It will be appreciated that additional, fewer, and/or a different order of steps may be performed in non-limiting embodiments. In some non-limiting embodiments, a step may be automatically performed in response to performance and/or completion of a prior step. At step 402, a user, with a computing device, performs an action that invokes (e.g., that may require) MFA. In non-limiting embodiments or aspects, such an action may include logging into an account associated with the user and/or entering into a transaction.

At step 404, based at least on the action of the user at step 402, a haptic PIN is generated and received with a computing device, such as a mobile device, personal computer, laptop computer, or the like. In non-limiting embodiments, the haptic PIN is received on a dedicated device that may solely receive a haptic PIN and allow for a responsive PIN to be entered therewith. Such a dedicated device may include one or more components of a computing device as described herein. The haptic PIN may be generated randomly or may be generated based on data, such as a numeric PIN, account identifier, and/or the like. A haptic PIN, as described herein, may be any arrangement and pattern of mechanical energy, such as a vibration pattern. In non-limiting embodiments or aspects, a haptic PIN, as described herein, may include a start sequence, which may alert the user that the haptic PIN has begun, and/or an end sequence, which may alert the user that the haptic PIN has ended. In non-limiting embodiments or aspects, start and/or end sequences may be vibrations of a certain duration that differ from the vibrations of the PIN itself, and thus, may be distinguishable to the user. In non-limiting embodiments or aspects, following a start sequence, a haptic PIN, as described herein, may include any number, pattern, and/or number of patterns of vibration(s), and may last for any suitable period of time. In non-limiting embodiments or aspects, the pattern may be based on a predetermined arrangement, such as, but not limited to Morse code or other arrangements of temporal signal patterns that are mapped to known digits and/or characters. In non-limiting embodiments or aspects, following a number and/or pattern of vibrations, a period of no vibrations may be provided, during which a user may, through an input device associated with the computing device, enter the same number and/or pattern of vibrations that was received. In non-limiting embodiments or aspects, the period of time during which no vibrations are provided is longer, for example, twice as long as the period of time for which vibrations are provided and/or the period of time between vibrations in a pattern, such that a user is capable of clearly distinguishing the end of a pattern, and has sufficient time to enter the PIN. This process may be repeated any number of times and, as noted above, may also be followed by an end sequence. In non-limiting embodiments or aspects, a start and/or end sequence may be a period of time where the vibration is constantly on, such that a user is capable of clearly distinguishing the start and/or end sequence from the haptic PIN. In non-limiting embodiments or aspects, a haptic PIN, as described herein, may have a predetermined duration during which the haptic PIN is valid. For example, after 1, 5, 10, 15, minutes, or any value therebetween, the device or system that generated the haptic PIN may be programmed and/or configured to cancel the haptic PIN, such that if a user attempts to enter a responsive PIN in response to the haptic PIN that was received, the device or system that generated the haptic PIN will be unable to compare the haptic PIN to the responsive PIN and, thus, be unable to authorize the original action.

With continuing reference to FIG. 4, following generation of the haptic PIN at step 404, in non-limiting embodiments or aspects, at step 406 a notification may be sent to the user's computing device, indicating that the haptic PIN has been generated. In non-limiting embodiments or aspects, such a notification may be sent automatically, in response to generation of the haptic PIN. The notification may be a push notification or any type of visual, audible, and/or haptic notification. At step 408, in non-limiting embodiments or aspects, a user may log-in to an authentication application, such as but not limited to that described herein and referenced in the description of FIG. 3 above, via which the haptic PIN may be transmitted to the user (step 410). As described above, a user may receive a haptic PIN (e.g., a challenge PIN), at step 410, and enter a PIN in response (e.g., a responsive PIN). In non-limiting embodiments or aspects, in step 412, the original action taken by a user may be authorized. In non-limiting embodiments or aspects, at step 410, the responsive PIN may be entered by user through an input device. In non-limiting embodiments or aspects, based on the original action, the responsive PIN may be entered into an authentication application, a website, a third-party website, and/or a third-party application. The responsive PIN may comprise a pattern of physical inputs (e.g., button presses, touchscreen presses, and/or the like) that match the pattern of the haptic PIN. In some non-limiting embodiments, the responsive PIN may be an electrical signal that is generated based on a user's manual inputs to match a haptic pattern (e.g., the haptic PIN). In some non-limiting embodiments, the responsive PIN may comprise numerical and/or alphanumerical inputs that a user determines based on the haptic PIN (e.g., a number of vibrations, Morse code translation, and/or the like).

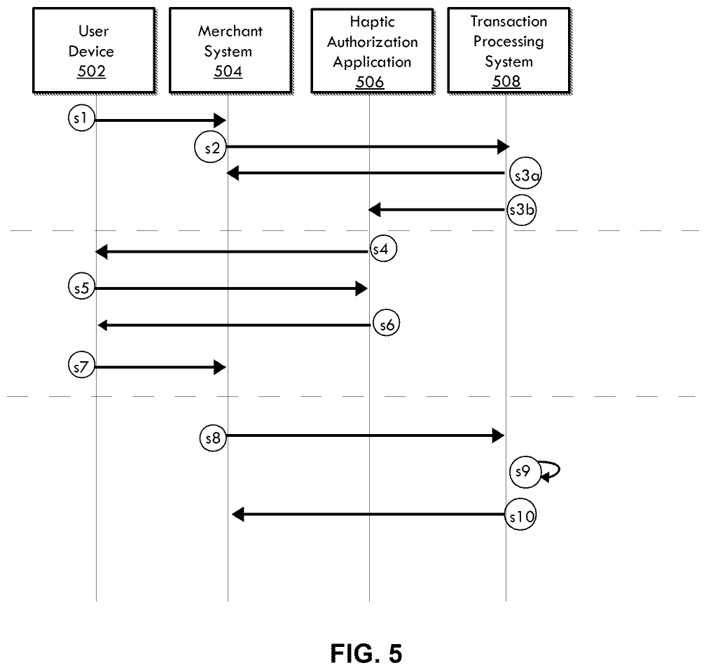

Turning to FIG. 5, shown is a non-limiting embodiment or aspect of a process of authorizing a transaction. In non-limiting embodiments or aspects, in step (s1) a user, for example, through user device 502, such as a payment device as described herein, initiates a transaction with merchant system 504. In non-limiting embodiments or aspects, such a transaction request may be through a website, such as an e-commerce website, through a mobile or other software application, or at a POS device. In non-limiting embodiments or aspects, in step (s2), merchant system 504 transmits a request to authorize the transaction to transaction processing system 508. While FIG. 5 exemplifies that transaction processing system 508 receives the authorization request, and performs other actions shown in FIG. 5 and described below, those of skill will appreciate that such actions may be undertaken by an acquirer system, an issuer system, and/or another system in communication with an electronic payment processing network.

In non-limiting embodiments or aspects, in step (s3a) transaction processing system 508 transmits to merchant system 504 an indication (e.g., such as a message) that MFA is required. In non-limiting embodiments or aspects, in step (s3b) transaction processing system 508 generates a haptic PIN. In non-limiting embodiments, step (s3a) occurs substantially simultaneously with step (s3b), although it will be appreciated that steps (s3a) and (s3b) may be separated in time. In non-limiting embodiments or aspects, a haptic PIN is transmitted from transaction processing system 508 via a haptic authorization application 506, for example, as described herein. In non-limiting embodiments or aspects, in step (s4), a notification is generated by haptic authorization application 506 and transmitted to and/or displayed on user device 502 in response to step (s3b) being performed. In non-limiting embodiments or aspects, in step (s5), a user logs into haptic authorization application 506. In non-limiting embodiments or aspects, in step (s6), following logging into haptic authorization application 506, the haptic PIN is presented (e.g., played back using a haptic driver) to the user on user device 502. In non-limiting embodiments or aspects, the haptic PIN is presented automatically following the user logging into haptic authorization application 506.

With continuing reference to FIG. 5, in non-limiting embodiments or aspects, in step (s7), a user, based on receipt of the haptic PIN, enters a responsive PIN. In non-limiting embodiments or aspects, the responsive PIN is entered into user device 502. In non-limiting embodiments or aspects, the responsive PIN is entered into a merchant system, for example, a POS device, website, and/or application. In non-limiting embodiments or aspects, the responsive PIN is entered into haptic authorization application 506. In non-limiting embodiments or aspects, in step (s8), the responsive PIN is transmitted to a transaction processing system, for example, by user device 502, merchant system 504, and/or haptic authorization application 506. In non-limiting embodiments or aspects, in step (s9), transaction processing system 508 compares the haptic PIN to the responsive PIN. Upon determining that the haptic PIN matches the responsive PIN, in step (s10), the transaction is authorized. In non-limiting embodiments or aspects, the transaction is authorized automatically in response to determining that the haptic PIN matches the responsive PIN. In non-limiting embodiments or aspects, transaction processing system 508 may transmit a notification to user device 502, merchant system 504, and/or haptic authorization application 506, that the transaction has been authorized.

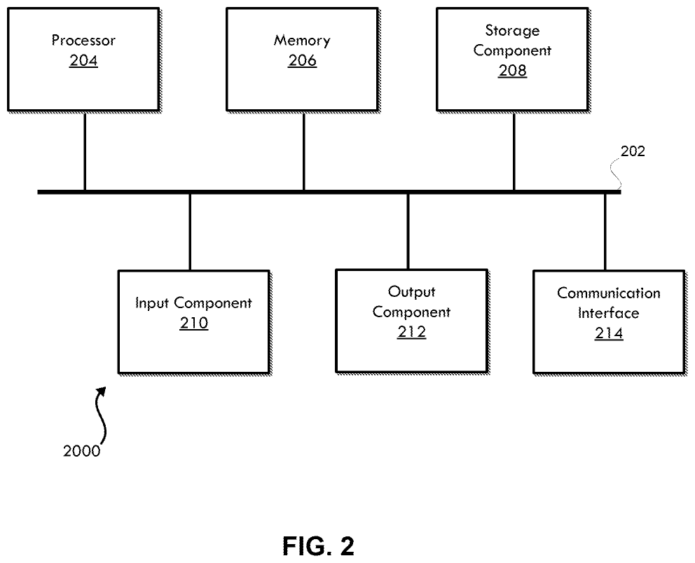

Referring now to FIG. 2, shown is a diagram of example components of a device 200 for carrying out any steps of the methods, described herein, according to non-limiting embodiments or aspects. Device 200 may correspond to a payment device, a POS device, a merchant system, a server a computer, a transaction processing system, a payment gateway, an acquirer institution system, a user device, an issuer system, and/or the like for carrying out the methods described herein. In non-limiting embodiments or aspects, such systems or devices may include at least one device 200 and/or at least one component of device 200. The number and arrangement of components shown are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a near—field communication (NFC) interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A non-transitory memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system for authorizing a transaction, comprising:
at least one processor configured to:
receive, from a merchant system, a request to authorize a transaction, the request comprising at least one token associated with a user;
determine, based at least on the at least one token, that the user requested a haptic personal identification number (PIN);
transmit, to a payment device associated with the user, a haptic PIN;
receive, from the payment device, a responsive PIN;
determine that the responsive PIN matches the haptic PIN; and
in response to determining that the responsive PIN matches the haptic PIN, automatically authorize the transaction.

2. The system of claim 1, wherein the responsive PIN is transmitted from the payment device to the merchant system and received by the at least one processor from the merchant system.

3. The system of claim 1, wherein the at least one token comprises at least two tokens.

4. The system of claim 3, wherein at least one first token of the at least two tokens comprises data relating to the haptic PIN, and wherein at least one second token of the at least two tokens comprises data relating to account information associated with the user.

5. The system of claim 1, wherein the at least one processor is further programmed or configured to transmit the haptic PIN via an application stored on the payment device.

6. The system of claim 5, wherein the at least one processor is further programmed or configured to generate a notification that the haptic PIN has been received in response to receiving the haptic PIN.

7. The system of claim 1, wherein the at least one processor is further programmed or configured to:
prior to receipt of the request to authorize the transaction, receive a request to generate the haptic PIN; and
generate the at least one token.

8. The system of claim 7, wherein the at least one processor is further programmed or configured to store, in a database, an association between the request to generate the haptic PIN and the at least one token.

9. The system of claim 1, wherein the at least one processor is further programmed or configured to transmit a notification to the merchant system and/or the payment device based on authorizing the transaction.

10. A computer-implemented method for authorizing a transaction, comprising:
receiving, with at least one processor, a request to authorize a transaction, the request comprising at least one token associated with a user;
querying, with at least one processor, a database to determine that the user is registered for a haptic personal identification number (PIN) based at least on the at least one token;
in response to determining that the user is registered for the haptic PIN, transmitting, with at least one processor, a haptic PIN to a payment device associated with the user;
receiving, with at least one processor, a user input comprising a pattern;
determining that the pattern matches the haptic PIN by comparing, with at least one processor, the pattern to the haptic PIN; and
in response to determining that the pattern matches the haptic PIN, authorizing, with at least one processor, the transaction.

11. The computer-implemented method of claim 10, wherein the at least one token comprises at least two tokens.

12. The computer-implemented method of claim 11, wherein at least one first token of the at least two tokens comprises data relating to the haptic PIN, and wherein at least one second token of the at least two tokens comprises data relating to account information associated with the user.

13. The computer-implemented method of claim 10, wherein the haptic PIN is transmitted to the payment device via an application stored on the payment device.

14. The computer-implemented method of claim 13, further comprising generating, with at least one processor and in response to receiving the haptic PIN, a notification that the haptic PIN has been received.

15. The computer-implemented method of claim 10, further comprising:
receiving, with at least one processor and prior to receiving the request to authorize the transaction, a request that the haptic PIN be generated; and
generating, with at least one processor, the at least one token.

16. The computer-implemented method of claim 15, further comprising storing, in a database and with at least one processor, an association of the request that the haptic PIN be generated and the at least one token.

17. The computer-implemented method of claim 10, further comprising transmitting, with at least one process and in response to authorizing the transaction, a notification to the payment device that the transaction is authorized.

18. A non-transitory, computer-readable medium, comprising programming instructions that, when executed by at least one processor, cause the at least one processor to:
receive, from a merchant system, a request to authorize a transaction, the request comprising at least one token associated with a user;
determine, based at least on the at least one token, that the user requested a haptic personal identification number (PIN);
transmit, to a payment device associated with the user, a haptic PIN;
receive, from the payment device, a responsive PIN;
determine that the responsive PIN matches the haptic PIN; and
in response to determining that the responsive PIN matches the haptic PIN, automatically authorize the transaction.

19. The non-transitory, computer-readable medium of claim 18, further comprising programming instructions that cause the at least one processor to generate a notification that the haptic PIN has been received.

20. The non-transitory, computer-readable medium of claim 18, further comprising programming instructions that cause the at least one processor to store, in a database, an association of a request that the haptic PIN be generated and the at least one token.
